(19) United States
(12) Patent Application Publication
(10) Pub. No.: US 2024/0191364 A1
(43) Pub. Date: Jun. 13, 2024

(54) HYDROGEN GENERATION AND CARBON DIOXIDE STORAGE SYSTEM CAPABLE OF SELECTIVELY DISSOLVING AND STORING CARBON DIOXIDE

(71) Applicants: HYUNDAI MOTOR COMPANY, Seoul (KR); KIA CORPORATION, Seoul (KR)

(72) Inventors: Yun Su Lee, Yongin-si (KR); Ji Hoon Jang, Suwon-si (KR)

(73) Assignees: HYUNDAI MOTOR COMPANY, Seoul (KR); KIA CORPORATION, Seoul (KR)

(21) Appl. No.: 18/143,390

(22) Filed: May 4, 2023

(30) Foreign Application Priority Data
Dec. 8, 2022 (KR) 10-2022-0170593

(51) Int. Cl. C25B 1/04; C25B 9/19; C25B 11/042; C25B 11/065; C25B 11/075; C25B 13/08; C25B 15/027; C25B 15/031; C25B 15/08

(52) U.S. Cl. CPC C25B 1/04; C25B 9/19; C25B 11/042; C25B 11/065; C25B 11/075; C25B 13/08; C25B 15/027; C25B 15/031; C25B 15/083

(57) ABSTRACT

A hydrogen generation and carbon dioxide storage system is capable of selectively dissolving and storing carbon dioxide contained in a mixed gas such as steel byproduct gas, exhaust gas, or the like. The system includes: a metal-carbon dioxide battery with an anode, a cathode, and a separator between the anode and the cathode; a first supply unit to supply a first electrolyte to the anode; a second supply unit to supply a second electrolyte to the cathode; a separation unit to separate hydrogen gas from a product discharged from the cathode; and a dissolution unit downstream of the separation unit to prepare a precursor by receiving a starting material and dissolving carbon dioxide in the starting material.

### CROSS-REFERENCE TO RELATED APPLICATION

This application claims, under 35 U.S.C. § 119(a), the benefit of priority from Korean Patent Application No. 10-2022-0170593, filed on Dec. 8, 2022, the entire contents of which are incorporated herein by reference.

### BACKGROUND

### (a) Technical Field

The present disclosure relates to a hydrogen generation and carbon dioxide storage system capable of selectively dissolving and storing carbon dioxide contained in a mixed gas such as steel byproduct gas, exhaust gas, and the like.

### (b) Background Art

Recently, thorough research into electrochemical water electrolysis has been conducted in line with the development of renewable energy to respond to climate change. In addition, the importance of carbon dioxide (CO₂) capture, storage, and conversion techniques for greenhouse gas reduction is growing.

Zinc/aluminum (Zn/Al)-based aqueous battery systems are very economical candidates for metal anodes in view of price and reserves. A zinc/aluminum (Zn/Al)-based aqueous battery system is configured to produce hydrogen and simultaneously capture carbon dioxide in the form of a salt such as potassium bicarbonate (KHCO₃).

### SUMMARY

An object of the present disclosure is to provide a hydrogen generation and carbon dioxide storage system that may directly use a mixed gas such as steel byproduct gas, exhaust gas, or the like without a separate purification process.

Another object of the present disclosure is to provide a hydrogen generation and carbon dioxide storage system in which the amount of carbon dioxide that is treated is increased compared to conventional systems.

Still another object of the present disclosure is to provide a hydrogen generation and carbon dioxide storage system in which the amount of alkali bicarbonate that is produced is increased compared to conventional systems.

The objects of the present disclosure are not limited to the foregoing. The objects of the present disclosure should be more clearly understood through the following description and may be realized by the systems described in the claims and combinations thereof.

An embodiment of the present disclosure provides a hydrogen generation and carbon dioxide storage system. The system includes a metal-carbon dioxide battery including an anode, a cathode, and a separator interposed between the anode and the cathode. The system also includes a first supply unit configured to supply a first electrolyte to the anode and a second supply unit configured to supply a second electrolyte including hydrogen ions and an aqueous alkali bicarbonate solution to the cathode. The system also includes a separation unit configured to separate hydrogen gas from a product discharged from the cathode and a dissolution unit disposed downstream of the separation unit. The dissolution unit is configured to prepare a precursor by receiving a starting material including water supplied from the outside and dissolving carbon dioxide contained in a mixed gas supplied from the outside in the starting material.

The system may further include a storage unit disposed between the separation unit and the dissolution unit. The storage unit may be configured to accommodate the starting material including the remaining product discharged from the separation unit and water supplied from the outside and to supply the starting material to the dissolution unit.

The system may further include a filtration unit disposed between the second supply unit and the dissolution unit. The filtration unit may be configured to prepare a second electrolyte by precipitating and separating alkali bicarbonate from the precursor fed from the dissolution unit and to supply the second electrolyte to the second supply unit.

The anode may include at least one of aluminum, zinc, or any combination thereof.

The cathode may include at least one of carbon paper, carbon fiber, carbon felt, carbon cloth, metal foam, metal foil, or any combination thereof. The cathode may alternatively include a catalytic metal supported on a support.

The separator may include a cationic conductive resin.

The first electrolyte may include at least one of an aqueous sodium hydroxide solution, an aqueous potassium hydroxide solution, or any combination thereof.

The aqueous alkali bicarbonate solution may include at least one of an aqueous sodium bicarbonate (NaHCO₃) solution, an aqueous potassium bicarbonate (KHCO₃) solution, or any combination thereof.

The second electrolyte may have a pH in a range of 8 to 9.

The temperature of the second electrolyte may be in a range of 0 degrees centigrade (° C.) to 25° C.

The concentration of the aqueous alkali bicarbonate solution contained in the second electrolyte may be in a range of 0.5 mole (M) to 2 M.

The dissolution unit may include a housing and a separator provided in the housing. The housing may include a first space inside the separator and a second space defined by an outer surface of the separator and an inner surface of the housing. The mixed gas may flow in the first space and the starting material may flow in the second space.

The mixed gas and the starting material may flow in a counterflow manner in the dissolution unit.

Carbon dioxide in the mixed gas may pass through the separator and may be dissolved in the starting material.

The mixed gas may include at least one of steel byproduct gas, exhaust gas, or any combination thereof.

The pressure of the first space may be in a range of 1 bar to 10 bar.

The ratio of a flow rate of carbon dioxide relative to a flow rate of the starting material in the dissolution unit (carbon dioxide/starting material) may be 0.001 to 5.

The filtration unit may include a cooler configured to precipitate alkali bicarbonate from the precursor by lowering the temperature of the precursor and a filter configured to separate the precipitated alkali bicarbonate.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 shows a hydrogen generation and carbon dioxide storage system according to the present disclosure; and

FIG. 2 shows a dissolution unit according to the present disclosure.

### DETAILED DESCRIPTION

The above and other objects, features, and advantages of the present disclosure should be more clearly understood from the following embodiments taken in conjunction with the accompanying drawings. However, the present disclosure is not limited to the embodiments disclosed herein and thus the embodiments may be modified into different forms. These embodiments are provided to thoroughly explain the technical concepts of the disclosure and to sufficiently transfer the spirit of the present disclosure to those of ordinary skill in the art.

Throughout the drawings, the same reference numerals refer to the same or like elements. For the sake of clarity of the present disclosure, the dimensions of structures may be depicted as being larger than the actual sizes thereof. It should be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, and variations thereof, when used in this specification, specify the presence of stated features, integers, steps, operations, elements, components, or combinations thereof. Such terms do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all expression, i.e., numbers, values, and/or representations that express the amounts of components, reaction conditions, polymer compositions, and mixtures used herein are to be taken as approximations including various uncertainties affecting measurement that inherently occur in obtaining these values, among others. Thus, these expression should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. The above note regarding the term “about” applies equally to such numerical ranges

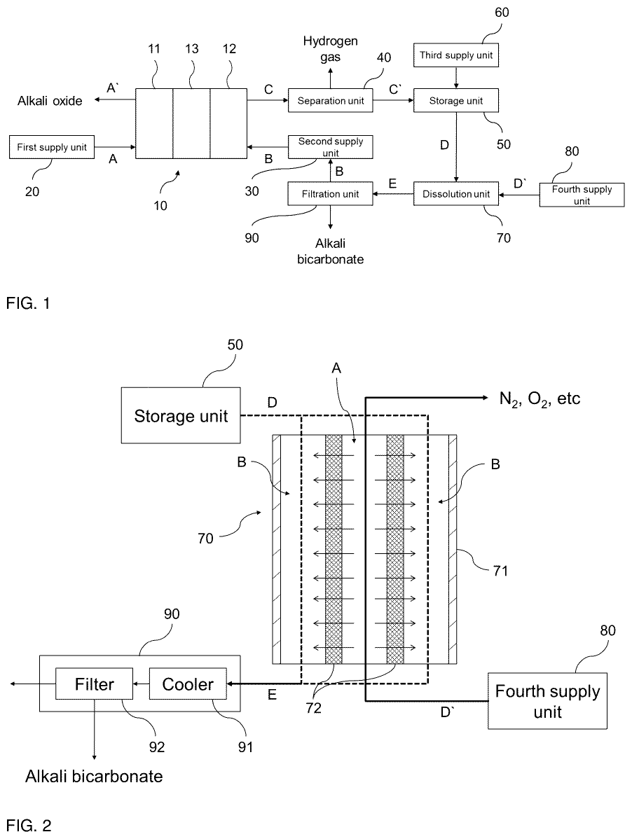

FIG. 1 shows a hydrogen generation and carbon dioxide storage system according to the present disclosure. The system may include a metal-carbon dioxide battery 10 having an anode 11, a cathode 12, and a separator 13 interposed between the anode 11 and the cathode 12. The system may also include a first supply unit 20 configured to supply a first electrolyte A to the anode 11 and may include a second supply unit 30 configured to supply a second electrolyte B to the cathode 12.

The anode 11 is an electrode made of a metal material and may include at least one of aluminum, zinc, or any combination thereof. The electrode material may instead consist of at least one of aluminum, zinc, or a combination thereof.

The first supply unit 20 may include a storage tank accommodating the first electrolyte A, a pump supplying the first electrolyte A to the anode 11, and the like.

The first electrolyte A may include at least one of an aqueous sodium hydroxide solution, an aqueous potassium hydroxide solution, or any combination thereof. The first electrolyte may instead consist of at least one of an aqueous sodium hydroxide solution, an aqueous potassium hydroxide solution, or a combination thereof.

In the anode 11, an oxidation reaction as shown in Scheme 1 below may occur. Scheme 1 below is represented when the anode 11 is zinc where Zn is zinc, Na⁺ is a sodium ion, OH⁻ is a hydroxide ion, ZnO is zinc oxide, and H₂O is water.

### Scheme 1

Zn+4Na⁺+40H⁻→4Na⁺+Zn(OH)₄²⁻+2e⁻

Zn(OH)₄²⁻→ZnO+H₂O+2OH⁻

Alkali oxides such as zinc oxide, etc. generated in the anode 11 are discharged to the outside. Alkali cations move to the cathode 12 through the separator 13.

The separator 13 is disposed between the anode 11 and the cathode 12 to prevent physical contact between the two components. Also, the separator 13 prevents mixing of the first electrolyte A and the second electrolyte B and conducts alkali cations generated from the anode 11 to the cathode 12.

The separator 13 may include a resin having cationic conductivity. For example, the separator 13 may include a perfluorosulfonic acid-based resin such as Nafion, or the like.

The cathode 12 induces reaction between the alkali cations moved through the separator 13 and the second electrolyte B to produce hydrogen and store carbon dioxide in the form of alkali bicarbonate.

The cathode 12 may include at least one of carbon paper, carbon fiber, carbon felt, carbon cloth, metal foam, metal foil, or any combination thereof. The cathode 12 may instead consist of at least one of carbon paper, carbon fiber, carbon felt, carbon cloth, metal foam, metal foil, or any combination thereof. Alternative, the cathode 12 may include a catalytic metal supported on a support. The type of catalytic metal is not particularly limited and may include noble metals such as platinum (Pt), or the like and/or may include transition metals such as nickel (Ni), molybdenum (Mo), or the like.

The second supply unit 30 may include a storage tank accommodating the second electrolyte B, a pump supplying the second electrolyte B to the cathode 12, and the like.

The second electrolyte B may include hydrogen ions, an aqueous alkali bicarbonate solution, and carbon dioxide. The second electrolyte B may further include an aqueous alkali carbonate solution, which is described below.

The aqueous alkali bicarbonate solution may include at least one of an aqueous sodium bicarbonate (NaHCO₃) solution, an aqueous potassium bicarbonate (KHCO₃) solution, or any combination thereof. The aqueous alkali bicarbonate solution may instead consist of at least one of an aqueous NaHCO₃ solution, an aqueous KHCO₃ solution, or a combination thereof.

The aqueous alkali carbonate solution may include at least one of an aqueous sodium carbonate (Na₂CO₃) solution, an aqueous potassium carbonate (K₂CO₃) solution, or any combination thereof. The aqueous alkali carbonate solution may instead consist of at least one of an aqueous Na₂CO₃ solution, an aqueous K₂CO₃ solution, or a combination thereof.

When the second electrolyte B is fed to the cathode 12, hydrogen gas is generated according to Scheme 2 below. Carbon dioxide is stored in the form of a salt according to Scheme 3 below where H⁺ is a hydrogen ion, e⁻ is an electron, H₂ is a hydrogen molecule, CO₂ is carbon dioxide, HCO₃⁻ is bicarbonate, and H⁺ is a hydrogen ion.

### Scheme 2

2H⁺+2e⁻→H₂

### Scheme 3

2Na⁺+Na₂CO₃+3CO₂+3H₂O→4Na⁺+4HCO₃⁻+2H⁺→4NaHCO₃+2H⁺Na⁺+HCO₃⁻→NaHCO₃

Accordingly, the product C discharged from the cathode 12 may include an unreacted material of the second electrolyte B, hydrogen gas, an aqueous alkali bicarbonate solution, and the like.

The system may include a separation unit 40 configured to separate hydrogen gas from the product C discharged from the cathode 12. The system may also include a storage unit 50 disposed downstream of the separation unit 40 and configured to prepare and accommodate a starting material D by mixing the remaining product C′ fed from the separation unit 40 with water supplied from the outside. The system may also include a dissolution unit 70 disposed downstream of the storage unit 50 and configured to prepare a precursor E by receiving the starting material D from the storage unit 50 and dissolving carbon dioxide contained in a mixed gas D′ supplied from the outside in the starting material D. The system may also include a filtration unit 90 disposed between the second supply unit 30 and the dissolution unit 70. The filtration unit 90 may be configured to prepare a second electrolyte B by precipitating and separating alkali bicarbonate from the precursor E fed from the dissolution unit 70 and to supply the second electrolyte B to the second supply unit 30.

The system is characterized in that it includes a kind of electrolyte circulation system including the separation unit 40, the storage unit 50, the dissolution unit 70, the filtration unit 90, and the second supply unit 30. The aqueous alkali bicarbonate solution may thereby be supplied at a predetermined concentration to the cathode 12, the amount of carbon dioxide that is treated may be increased, and alkali bicarbonate may be produced.

The separation unit 40 may include a gas-liquid separation device configured to separate hydrogen gas from the liquid product C discharged from the cathode 12.

The separation unit 40 may feed the product C′ from which hydrogen gas is separated to the storage unit 50. The product C′ from which the hydrogen gas is separated may include an unreacted material of the second electrolyte B, an aqueous alkali bicarbonate solution, and the like.

Also, the system may include a third supply unit 60 configured to supply water to the storage unit 50. In the system, since water is consumed according to Scheme 2 and Scheme 3 as described above, water may be supplemented through the third supply unit 60.

The third supply unit 60 is able to further supply an aqueous alkali carbonate solution to the storage unit 50 in addition to water.

The storage unit 50 may include a storage tank accommodating the starting material D composed of the product C′ from which hydrogen gas is separated. The storage tank may also accommodate water and/or an aqueous alkali carbonate solution fed from the third supply unit 60. The storage unit 50 may also include a pump supplying the starting material D to the dissolution unit 70 and the like.

FIG. 2 shows the dissolution unit 70. The dissolution unit 70 may include a housing 71 and a separator 72 provided in the housing 71.

Also, the system may include a fourth supply unit 80 configured to supply a mixed gas containing carbon dioxide to the dissolution unit 70.

The mixed gas D′ may be a gas in which carbon dioxide, nitrogen, oxygen, hydrogen, and the like are mixed. Specifically, the mixed gas D′ may include at least one of steel byproduct gas, exhaust gas, or any combination thereof. The mixed gas D′ may instead consist of at least one of steel byproduct gas, exhaust gas, or a combination thereof.

In order to use steel byproduct gas, exhaust gas, or the like in the existing system, carbon dioxide has to be separated from the steel byproduct gas, exhaust gas, or the like, dissolved in an electrolyte, and then supplied to the metal-carbon dioxide battery 10. Hence, the scale and cost of the system increase. The present disclosure provides a system capable of selectively dissolving and storing carbon dioxide through the dissolution unit 70 without performing any pretreatment for steel byproduct gas, exhaust gas, and the like.

The housing 71 may include a first space A inside the separator 72 and a second space B defined by an outer surface of the separator 72 and an inner surface of the housing 71.

The mixed gas D′ may be fed to the first space A and the starting material D may be fed to the second space B. The mixed gas D′ and the starting material D may flow in a counterflow manner in opposite flow directions. For example, as shown in FIG. 2, when the mixed gas D′ is fed to the lower portion of the dissolution unit 70 and discharged from the upper portion thereof, the starting material D may be fed to the upper portion of the dissolution unit 70 and discharged from the lower portion thereof. This serves to increase the contact time between the mixed gas D′ and the starting material D.

The separator 72 may include a hollow fiber made of a polyolefin material such as polypropylene or the like. The surface of the separator 72 is in the form of micropores through which the starting material D cannot diffuse and the mixed gas D′ may pass.

Of the mixed gas D′ flowing in the first space A, carbon dioxide has high solubility in the starting material D at high pressure, but other gases, such as nitrogen, oxygen, or the like have low solubility in the starting material D. Accordingly, at the interface between the mixed gas D′ and the separator 72, carbon dioxide passes through the separator 72 and is dissolved in the starting material D and separated therefrom, and the other gases are discharged.

The carbon dioxide dissolution reaction is shown in Scheme 4 and Scheme 5 below. Scheme 5 is represented when an aqueous alkali carbonate solution is supplied along with water using the third supply unit 60.

### Scheme 4

CO₂+H₂O→H⁺+HCO₃⁻

### Scheme 5

CO₂+Na₂CO₃+H₂O→2NaHCO₃

The pressure of the first space A may be adjusted to within a range of 1 bar to 10 bar in order to cause dissolution of carbon dioxide. The dissolution unit 70 may further include a sensor configured to measure the pressure of the first space A, a pressure controller configured to control the pressure, and the like. When the pressure of the first space A falls within the above numerical range, carbon dioxide may be selectively dissolved in the starting material D.

In addition, the ratio of the flow rate of carbon dioxide relative to the flow rate of the starting material D in the dissolution unit 70 (carbon dioxide/starting material) may be 0.001 to 5. When the ratio of flow rates falls within the above range, the starting material D and carbon dioxide may come into efficient contact with each other.

The dissolution unit 70 is able to supply the precursor E obtained through dissolution reaction of carbon dioxide to the filtration unit 90. The filtration unit 90 may include a cooler 91 configured to precipitate alkali bicarbonate from the precursor E by lowering the temperature of the precursor E and a filter 92 configured to separate the precipitated alkali bicarbonate. When the temperature of the precursor E is lowered by the cooler 91, alkali bicarbonate is decreased in solubility and thus precipitated. The alkali bicarbonate that is precipitated may be easily separated and recovered through the filter 92.

The cooler 91 is able to cool the precursor E to within a range of 0 degrees centigrade (° C.) to 25° C., or to within a range of 5° C. to 10° C.

The second electrolyte B may be obtained by precipitating and separating alkali bicarbonate from the precursor E.

The pH of the second electrolyte B may be within a range of 8 to 9, the temperature thereof may be within a range of 0° C. to 25° C., and the concentration of the aqueous alkali bicarbonate solution contained therein may be 0.5 mole (M) to 2 M.

A better understanding of the present disclosure may be obtained through the following examples. These examples are merely set forth to illustrate the present disclosure, and are not to be construed as limiting the scope of the present disclosure.

### Example 1

A system as shown in FIG. 1 was constructed. Zinc foil was used as an anode and nickel-molybdenum supported on a support was used as a cathode. A battery was manufactured by interposing Nafion as a separator between the anode and the cathode.

A 6 M aqueous sodium hydroxide (NaOH) solution was fed to the anode.

A separation unit was prepared as follows. A separator that was used was composed of a hollow fiber made of polypropylene. A mixed gas including carbon dioxide, nitrogen, and oxygen in a volume ratio of 0.24:0.74:0.02 was fed to the first space inside the separator, and a starting material including 1 M aqueous sodium bicarbonate (NaHCO₃) solution and water was fed to the second space between the separator and the housing. The pressure of the first space was adjusted to about 1 bar to 10 bar, and the gas/liquid differential pressure was adjusted to about 0 to 5 bar. A carbon dioxide dissolution rate (absorption rate) was determined by measuring the amount of carbon dioxide contained in the mixed gas upstream and downstream of the separator. The result thereof was about 98%.

The precursor discharged from the separation unit was converted into a second electrolyte through the filtration unit, which was then supplied to the cathode.

The cell current density of the system was about 80 mA/cm² (@ 0.3V).

### Example 2

A system as shown in FIG. 1 was constructed. Zinc foil was used as an anode and nickel-molybdenum supported on a support was used as a cathode. A battery was manufactured by interposing Nafion as a separator between the anode and the cathode.

A 6 M aqueous NaOH solution was fed to the anode.

A separation unit was prepared as follows. A separator that was used was composed of a hollow fiber made of polypropylene. A mixed gas including carbon dioxide, nitrogen, and oxygen in a volume ratio of 0.24:0.74:0.02 was fed to the first space inside the separator, and a starting material including 1 M aqueous NaHCO₃ solution, a 0.5 M aqueous Na₂CO₃ solution, and water was fed to the second space between the separator and the housing. The pressure of the first space was adjusted to about 1 bar to 10 bar, and the gas/liquid differential pressure was adjusted to about 0 to 5 bar. A carbon dioxide dissolution rate (absorption rate) was determined by measuring the amount of carbon dioxide contained in the mixed gas upstream and downstream of the separator. The result thereof was about 99%.

The precursor discharged from the separation unit was converted into a second electrolyte through the filtration unit, which was then supplied to the cathode.

The cell current density of the system was about 80 mA/cm² (@ 0.3V).

As is apparent from the above description, according to the present disclosure, it is possible to provide a hydrogen generation and carbon dioxide storage system that can directly use a mixed gas such as steel byproduct gas, exhaust gas, or the like without a separate purification process.

According to the present disclosure, it is possible to provide a hydrogen generation and carbon dioxide storage system in which the amount of carbon dioxide that is treated is increased compared to conventional systems.

According to the present disclosure, it is possible to obtain a hydrogen generation and carbon dioxide storage system in which the amount of alkali bicarbonate that is produced is increased compared to conventional systems.

The effects of the present disclosure are not limited to the above-mentioned effects. It should be understood that the effects of the present disclosure include all effects that can be inferred from the description of the present disclosure.

Although the test examples and examples of the present disclosure have been described in detail as described above, the scope of the present disclosure is not limited to such test examples and examples. Various modifications and improvements made by those of ordinary skill in the art using the basic concept of the present disclosure defined in the following claims are also included in the scope of the present disclosure.

What is claimed is:

1. A hydrogen generation and carbon dioxide storage system, the system comprising:
a metal-carbon dioxide battery including an anode, a cathode, and a separator interposed between the anode and the cathode;
a first supply unit configured to supply a first electrolyte to the anode;
a second supply unit configured to supply a second electrolyte including hydrogen ions and an aqueous alkali bicarbonate solution to the cathode;
a separation unit configured to separate hydrogen gas from a product discharged from the cathode; and
a dissolution unit disposed downstream of the separation unit and configured to prepare a precursor by receiving a starting material including water supplied from outside and dissolving carbon dioxide contained in a mixed gas supplied from outside in the starting material.

2. The system of claim 1, further comprising:
a storage unit disposed between the separation unit and the dissolution unit and configured to accommodate the starting material, which includes a remaining product discharged from the separation unit and water supplied from outside, and to supply the starting material to the dissolution unit.

3. The system of claim 1, further comprising:
a filtration unit disposed between the second supply unit and the dissolution unit and configured to prepare a second electrolyte by precipitating and separating alkali bicarbonate from the precursor fed from the dissolution unit and to supply the second electrolyte to the second supply unit.

4. The system of claim 3, wherein the filtration unit comprises a cooler configured to precipitate alkali bicarbonate from the precursor by lowering a temperature of the precursor and a filter configured to separate the precipitated alkali bicarbonate.

5. The system of claim 1, wherein the anode comprises at least one of aluminum, zinc, or any combination thereof.

6. The system of claim 1, wherein the cathode comprises at least one of carbon paper, carbon fiber, carbon felt, carbon cloth, metal foam, metal foil, or any combination thereof, or wherein the cathode comprises a catalytic metal supported on a support.

7. The system of claim 1, wherein the separator comprises a cationic conductive resin.

8. The system of claim 1, wherein the first electrolyte comprises at least one of an aqueous sodium hydroxide solution, an aqueous potassium hydroxide solution, or any combination thereof.

9. The system of claim 1, wherein the aqueous alkali bicarbonate solution comprises at least one of an aqueous sodium bicarbonate (NaHCO₃) solution, an aqueous potassium bicarbonate (KHCO₃) solution, or any combination thereof.

10. The of claim 1, wherein the second electrolyte has a pH in a range of 8 to 9.

11. The of claim 1, wherein a temperature of the second electrolyte is in a range of 0 degrees centigrade (° C.) to 25° C.

12. The system of claim 1, wherein a concentration of the aqueous alkali bicarbonate solution contained in the second electrolyte is in a range of 0.5 mole (M) to 2 M.

13. The system of claim 1, wherein the dissolution unit comprises a housing and a separator provided in the housing, wherein the housing comprises a first space inside the separator and a second space defined by an outer surface of the separator and an inner surface of the housing, and wherein the mixed gas flows in the first space and the starting material flows in the second space.

14. The system of claim 13, wherein the mixed gas and the starting material flow in a counterflow manner in the dissolution unit.

15. The system of claim 13, wherein carbon dioxide in the mixed gas passes through the separator and is dissolved in the starting material.

16. The system of claim 13, wherein the mixed gas comprises at least one of steel byproduct gas, exhaust gas, or any combination thereof.

17. The system of claim 13, wherein a pressure of the first space is in a range of 1 bar to 10 bar.

18. The system of claim 13, wherein a ratio of a flow rate of carbon dioxide relative to a flow rate of the starting material in the dissolution unit (carbon dioxide/starting material) is in a range of 0.001 to 5.
